(19) United States
(12) Patent Application Publication
(10) Pub. No.: US 2007/0127438 A1
(43) Pub. Date: Jun. 7, 2007

(54) Method and system for processing telephone technical support

(76) Inventors: Scott Newman, Little Elm, TX (US); Eric Bearden, Forney, TX (US); John-Paul Roadman, Carollton, TX (US); Jonathan Paden, Austin, TX (US)

Correspondence Address: BRINKS HOFER GILSON & LIONE, P.O. BOX 10395, CHICAGO, IL, 60610, US

(21) Appl. No.: 11/291,499

(22) Filed: Dec. 1, 2005

(51) Int. Cl. H04L 12/66

(52) U.S. Cl. 370/352

(57) ABSTRACT

A system and method for processing telephone technical support is disclosed. The method and system monitor an authentication record comprising previous authentication attempts at a service provider, identify a user having at least one failed login attempt based upon the authentication record, monitor incoming telephone calls for a call from the user, and provide a response to the user related to an alternate login mechanism.

### TECHNICAL FIELD

The present disclosure generally relates to methods and systems for processing telephone technical support.

### BACKGROUND

There is growing demand by consumers for network services, such as Internet access, provided by Internet service providers (“ISP”). Customers of the ISP may access the Internet via dial up connection, a cable modem or a digital subscriber line (“DSL”). In order for a customer of an ISP to access the Internet or other network services provided by the ISP, the customer must first successfully login into the ISP's network. This may be done by supplying login information including a login and password. The ISP will authenticate the login information provided by the customer. Once authenticated, network services will then be provided to the customer.

Customers experiencing issues, such as an inability to connect with their ISP, will inevitably contact the service provider. One way to contact the ISP is through telephone. In the past, a customer service representative (“CSR”) of the ISP would utilize a variety of different tools in order to identify the customer, determine the customer's issue and attempt to solve the customer's issue. In order to accomplish this, the CSR may need information from the customer including the customer's identity, the devices the customer is using and the status of those devices.

One common reoccurring connection issue is the customer's inability to login to the ISP's network. This may be due to a forgotten login and/or password. Unfortunately, resolving this issue is very time consuming, making the procedure frustrating to the customer and costly to the ISP. Therefore, there exists a need for a system that can more efficiently handle customer calls relating to login issues.

### BRIEF DESCRIPTION OF THE DRAWINGS

FIG. 1 is a block diagram of an embodiment of a customer information access system;

FIG. 2 is a block diagram of a flow chart illustrating one method the customer information access system may utilize; and

FIG. 3 is a block diagram of a general purpose computer.

### DETAILED DESCRIPTION

In one embodiment, a user information access system includes a first interface connectable to a customer telephone and a second interface connectable to a remote device, such as the user's DSL modem. The system is configured to monitor an authentication record containing the remote device's previous authentication attempts for at least one failed login attempt, identify the user of the at least one failed login attempt, monitor incoming telephone calls to detect a call from the user of the at least one failed login attempt, access a user information record, determine if the user is having an authentication problem based upon the authentication record and the user information record and provide a response to the user based upon the determination of if the user is having an authentication problem.

The system may a third interface connectable to a customer service representative's computer and a fourth interface connectable to the customer service representative's telephone. The system may then be configured to place a customer service representative in contact with the user via the fourth interface and provide the authentication record and the user information record to the customer service representative via the third interface.

These and other aspects and advantages are evident in the detailed description which follows.

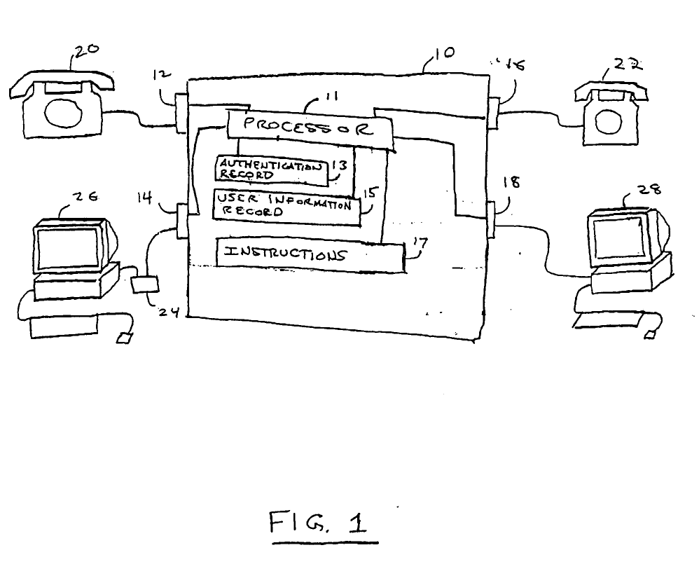

Referring to FIG. 1, a customer information access system 10 is shown. The customer information access system 10 includes a processor 11, such as an Intel Pentium 4, connected to a first interface 12, a second interface 14, a third interface 16 and a fourth interface 18. The first interface 12 and the third interface 16 are connected to a customer's telephone 20 and a customer service representative's telephone 22, respectively. The customer's telephone 20 and/or the customer service representative's telephone 22 can be connected to the customer information access system 10 using a wired or wireless communication path, a public switch telephone network or other means suitable of communicating information between electronic devices.

The third interface 14 is connected to a remote device 24. The device 24 may be a DSL modem connected to a customer's personal computer 26. The third interface 14 may be connected to the device 24 via wired or wireless communication means or by any means suitable for communication between electronic devices.

The fourth interface 18 is connected to a customer service representative's computer 28. The customer service representative's computer 28 may be connected to the fourth interface 18 via wired or wireless communication means or by any means suitable for communication between electronic devices.

The processor 11 is in communication with an authentication record database 13 and a user information record database 15. One or both of the authentication record database 13 and the user information database 15 may reside in a storage system located within the system 10. The storage system may be a hard drive, optical media device, solid state device or any device capable of storing electronic information. Alternatively one or both of authentication record database and the user information record database may reside in a remote location.

The authentication record database 13 may be a remote authentication dial in user service (“RADIUS”) log. The RADIUS log contains both successful and unsuccessful log in attempts made by a user. The user information record database 15 may be a lightweight directory access protocol (“LDAP”) record. The LDAP contains user information related to if the user is a current customer. In addition, the LDAP record may contain information related customer billing.

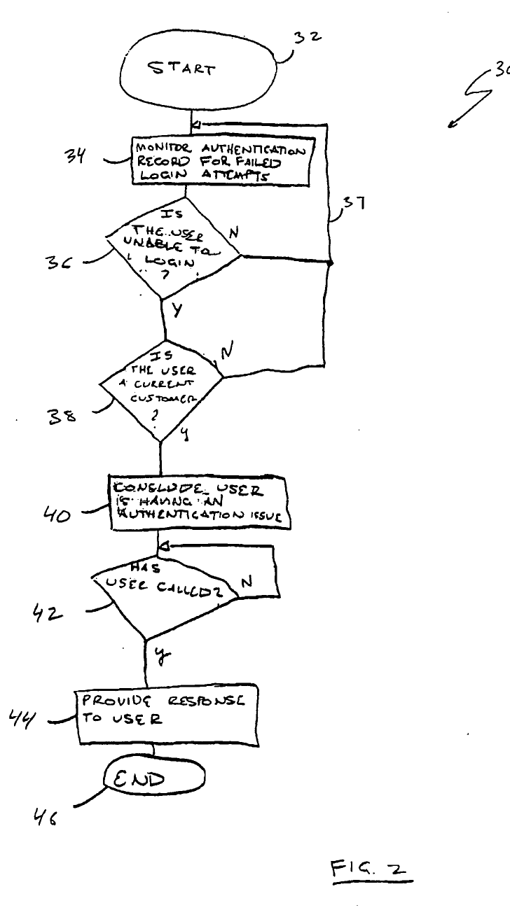

Last, the processor 11 is also in communication with a logic device 17 containing processor executable instructions for executing a method 30 shown in FIG. 2 and described below.

Referring to FIGS. 1 and 2, the method 30 executed by the processor 11 is shown. Block 32 denotes the start of the method 30. In block 34, the system 10 monitors an authentication record for failed log in attempts.

Next, as shown in block 36, the processor 11 determines if a user is unable to log in. The processor 11 may make this determination by monitoring the last five log in attempts. If the last five log in attempts have all failed, the processor 11 will determine that the user is unable to log in. If the processor 11 determines that the user is unable to log in, the method 30 proceeds to block 38. Otherwise, the method 30 will follow line 37 and restart the method 30.

In block 38, a determination is made if the user is a current customer. This may be accomplished by accessing a user information record which contains information indicating if the user is a current customer. If a user is not a current customer, as indicated by the user information record, the user will not be able to log in to the ISP. Thus, if it is determined that the user is not a current customer, the method will follow line 37 and restart. Otherwise, the method will proceed to block 40.

In block 40, the processor 11 will conclude that the user is having an authentication issue because the user is unable to log in and the user is a current customer. Thereafter, as shown in block 42, the processor 11 will monitor incoming telephone calls to determine if the user is calling the ISP. The processor 11 may determine that the user is calling by matching the user's name with the number of incoming telephone calls. Telephone numbers may be obtained by using a caller ID system. Additionally or alternatively, the processor 11 may obtain telephone numbers of incoming telephone calls by requiring all incoming callers to provide their telephone number by touch tone or voice. Once the system has determined that the user is calling the ISP, the system will provide a response related to an alternate login mechanism to user as shown in block 44.

The response related to the alternate login mechanism to the user may be a prerecorded message giving the user instructions related to logging in to the ISP. These instructions may include directions for changing the log in and password of the user or may be the current log in and password. Alternatively, the system may put the user in contact with a customer service representative via the CSR's telephone 22. Furthermore, the CSR may be provided with information regarding the customer's previous log in attempts and other customer information via the CSR's personal computer 28. After block 44 has been executed, the method ends as denoted by block 46.

By executing the method 30, the system 10 will be able to identify customers having log in problems. After being identified, the system will monitor for the customer's telephone call. Once the telephone call is received, the system will automatically provide instructions to the customer for correcting the log in problem. This is advantageous because a large number of customer service calls may relate to log in problems. By implementing the system and method, service providers will be able to more efficiently handle other customer telephone calls not related to log in problems because the system and method will handle those duties automatically.

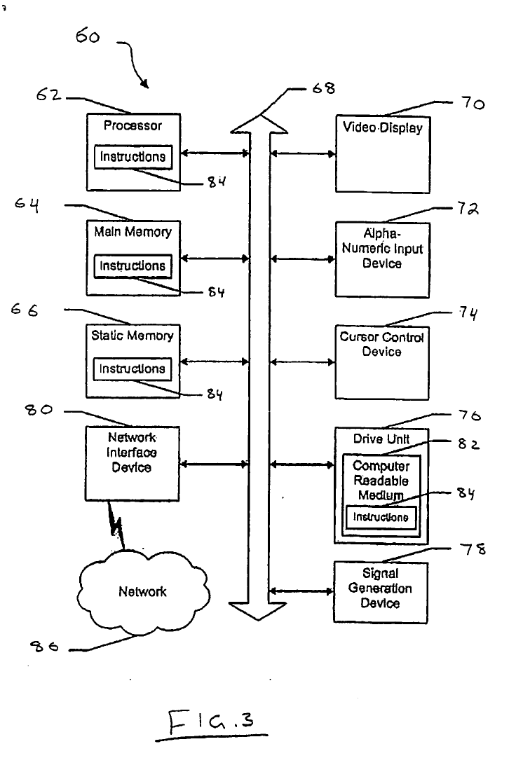

Referring to FIG. 3, an illustrative embodiment of a general computer system is shown and is designated 60. The computer system 60 can include a set of instructions that can be executed to cause the computer system 60 to perform any one or more of the methods or computer based functions disclosed herein. The computer system 60 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 60 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 60 can be implemented using electronic devices that provide voice, video or data communication. Further, while a single computer system 60 is illustrated, the term “system” shall also be taken to include any collection of systems or sub-systems that individually or jointly execute a set, or multiple sets, of instructions to perform one or more computer functions.

As illustrated in FIG. 3, the computer system 60 may include a processor 62, e.g., a central processing unit (CPU), a graphics processing unit (GPU), or both. Moreover, the computer system 60 can include a main memory 64 and a static memory 66 that can communicate with each other via a bus 68. As shown, the computer system 60 may further include a video display unit 70, such as a liquid crystal display (LCD), an organic light emitting diode (OLED), a flat panel display, a solid state display, or a cathode ray tube (CRT). Additionally, the computer system 60 may include an input device 72, such as a keyboard, and a cursor control device 74, such as a mouse. The computer system 60 can also include a disk drive unit 76, a signal generation device 78, such as a speaker or remote control, and a network interface device 80.

In a particular embodiment, as depicted in FIG. 3, the disk drive unit 76 may include a computer-readable medium 84 in which one or more sets of instructions 84, e.g. software, can be embedded. Further, the instructions 84 may embody one or more of the methods or logic as described herein. In a particular embodiment, the instructions 84 may reside completely, or at least partially, within the main memory 64, the static memory 66, and/or within the processor 62 during execution by the computer system 60. The main memory 64 and the processor 62 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 84 or receives and executes instructions 84 responsive to a propagated signal, so that a device connected to a network 86 can communicate voice, video or data over the network 86. Further, the instructions 84 may be transmitted or received over the network 86 via the network interface device 80.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

1. A method of processing support calls comprising:
monitoring an authentication record comprising previous authentication attempts at a service provider;
identifying a user having at least one failed login attempt based upon the authentication record;
monitoring incoming telephone calls for a call from the user; and
providing a response to the user related to an alternate login mechanism.

2. The method of claim 1, further comprising the steps of:
accessing a user information record;
determining if the user is a current customer based upon the user information record; and
wherein providing the response further comprises the step of providing a response to the user based upon the determination of if the user is a current customer.

3. The method of claim 1, further comprising the steps of:
placing a customer service representative in contact with the user; and
providing the authentication record and the user information record to the customer service representative.

4. The method of claim 1, further comprising the step of providing a pre-recorded message to the user based upon the authentication record and the user information record.

5. The method of claim 1, wherein identifying the user further comprises the step of obtaining the user's telephone number.

6. The method of claim 5, wherein the step of obtaining the user's telephone number further comprises the step of obtaining the user's telephone number via a caller ID system.

7. The method of claim 5, wherein obtaining the user's telephone number further comprises the step of obtaining the user's telephone number by having the user manually enter the user's telephone number.

8. The method of claim 1, wherein the authentication record is a remote authentication dial-in user service (“RADIUS”) log.

9. The method of claim 1, wherein the user information record is a lightweight directory access protocol (“LDAP”) record.

10. The method of claim 1, wherein the service provider is an Internet service provider

11. A system comprising:
a processor, the processor having instructions executable by the processor;
a first storage device in communication with the processor, the first storage device having an authentication record;
the instructions configuring the processor to monitor an authentication record comprising previous authentication attempts at a service provider, identify a user having at least one failed login attempt based upon the authentication record, monitor incoming telephone calls for a call from the user, and provide a response to the user related to an alternate login mechanism.

12. The system of claim 1, further comprising:
a a second storage device in communication with the processor, the second storage device having a user information record; and
the instructions further configure the processor access a user information record, determine if the user is a current customer based upon the user information record and providing a second response to the user based upon the determination of if the user is a current customer.

13. The system of claim 11, wherein the authentication record is a remote authentication dial-in user service (“RADIUS”) log.

14. The system of claim 11, wherein the user information record is a lightweight directory access protocol (“LDAP”) record.

15. The system of claim 11, wherein the service provider is an Internet service provider.

16. A computer readable medium storing a computer program, the computer readable medium comprising:
an authentication monitoring code segment that monitors an authentication record comprising previous authentication attempts at a service provider;
an identifying code segment that identifies a user having at least one failed login attempt based upon the authentication record;
a telephone monitoring code segment that monitors incoming telephone calls for a call from the user; and
a providing a response code segment that provides a response to the user related to an alternate login mechanism.

17. The computer readable medium of claim 16, further comprising a current customer code segment that determines if the user is a current customer based upon a user information record.

18. The computer readable medium of claim 16, wherein the authentication record is a remote authentication dial-in user service (“RADIUS”) log.

19. The computer readable medium of claim 16, wherein the user information record is a lightweight directory access protocol (“LDAP”) record.

20. The computer readable medium of claim 16, wherein the service provider is an Internet service provider.

21. A method for assisting a user, the method comprising:
providing a failed login attempt by a user to a service provider;
detecting a failed login attempt;
contacting the service provider via a telephone call by the user;
monitoring incoming telephone calls for the telephone call by the user; and
providing a response related to an alternate login mechanism.

22. The method of claim 21, further comprising the steps of:
connecting a customer service representative to the user; and
providing an authentication record and a user information record to the customer service representative.

23. The method of claim 21, further comprising the step of providing a pre-recorded message to the user.

24. The method of claim 21, wherein the authentication record is a remote authentication dial-in user service (“RADIUS”) log.

25. The method of claim 21, wherein the user information record is a lightweight directory access protocol (“LDAP”) record.

26. The method of claim 21, wherein the service provider is an Internet service provider
